(19) United States
(12) Patent Application Publication
(10) Pub. No.: US 2017/0161669 A1
(43) Pub. Date: Jun. 8, 2017

(54) METHOD AND SYSTEM FOR SUBMITTING CONTENT DELIVERY TASKS

(71) Applicants: LE HOLDINGS (BEIJING) CO., LTD., Beijing (CN); LECLOUD COMPUTING CO., LTD., Beijing (CN)

(72) Inventors: Hao CHEN, Beijing (CN); Jun GAO, Beijing (CN); Yuxin CHEN, Beijing (CN); Changfu LIU, Beijing (CN)

(21) Appl. No.: 15/246,160

(22) Filed: Aug. 24, 2016

Related U.S. Application Data
(63) Continuation of application No. PCT/CN2016/088879, filed on Jul. 6, 2016.

(30) Foreign Application Priority Data
Dec. 7, 2015 (CN) 201510890637.7

(51) Int. Cl. G06Q 10/06

(52) U.S. Cl. CPC G06Q 10/063112; G06Q 10/063116

(57) ABSTRACT

A submitting method, system, and non-transitory computer-readable medium are provided for content delivery tasks. The method includes: receiving a plurality of task submitting requests from a plurality of users, allocating the plurality of task submitting requests to a plurality of task submitting queues according to a priority level of each user in a user priority level model where each task submitting queue corresponds to a submitting priority level, and submitting the plurality of task submitting queues to a distribution server according to the submitting priority levels.

### CROSS REFERENCE TO RELATED APPLICATIONS

This application is a continuation of International Application No. PCT/CN2016/088879, filed on Jul. 6, 2016, which is based upon and claims priority to Chinese Patent Application No. 201510890637.7, filed on Dec. 7, 2015, the entire contents of both of which are incorporated herein by reference.

### TECHNICAL FIELD

The embodiments of the present disclosure relate to the content delivery network (CDN) field, and in particular to a submitting method and system for content delivery tasks.

### BACKGROUND

A content delivery network (CDN) is a distributed network formed of node server clusters distributed in different regions, which pushes, according to certain rules, content sources such as Internet websites, website videos and network games to the network edge node servers close to a user, such that the user can obtain the needed content nearby. This is an important means for remitting the Internet network congestion, increasing the Internet business response speed and improving the user business experience.

### SUMMARY

The embodiments of the present disclosure provides a submitting method, electronic device and non-transitory computer-readable medium for content delivery tasks.

In one aspect, the present disclosure provides a submitting method for content delivery tasks. The method may include receiving a plurality of task submitting requests from a plurality of users, allocating the plurality of task submitting requests to a plurality of task submitting queues according to a priority level of each user in a user priority level model where each task submitting queue may correspond to a submitting priority level, and submitting the plurality of task submitting queues to a distribution server according to the submitting priority levels.

In another aspect, the present disclosure provides an electronic device for content delivery tasks. The electronic device may include at least one processor, and a memory communicably connected with the at least one processor for storing instructions executable by the at least one processor, wherein execution of the instructions by the at least one processor causes the at least one processor to: receive a plurality of task submitting requests from a plurality of users, allocate the plurality of task submitting requests to a plurality of task submitting queues according to a priority level of each user in a user priority level model, wherein each task submitting queue corresponds to a submitting priority level, and submit the plurality of task submitting queue to a distribution server according to the submitting priority level.

In an additional aspect, the present disclosure provides a non-transitory computer-readable medium for content delivery tasks. The non-transitory computer-readable medium may include executable instructions, wherein the executable instructions, when executed by a processor, cause the processor to: receive a plurality of task submitting requests from a plurality of users, allocate the plurality of task submitting requests to a plurality of task submitting queues according to a priority level of each user in a user priority level model wherein each task submitting queue may correspond to a submitting priority level, and submit the plurality of task submitting queues to a distribution server according to the submitting priority levels.

It should be understood that both the foregoing general description and the following detailed description are exemplary and explanatory only and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the embodiments of the present disclosure, figures to be used in the embodiments will be briefly introduced in the following. Apparently, figures in the following description are some embodiments of the present disclosure, and other figures can be obtained by those skilled in the art based on these figures without inventive efforts.

FIG. 1 is a flow chart of the submitting method for content delivery tasks of one embodiment of the present disclosure;

FIG. 2 is a schematic structural view of the submitting system for content delivery tasks of one embodiment of the present disclosure; and

FIG. 3 is a schematic structural view of a device that implements the submitting method for content delivery tasks of the embodiments of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

Content delivery is a fundamental function of the CDN service, which loads contents (such as videos and software, etc.) to an edge node and then opens access for the user, so as to improve the access efficiency of the initial visit of the user. The specific procedures are as below: after receiving a task submitting request from a customer, the source server receives the documents in the task, delivers the documents to all CDN node servers; and after all the CDN node servers store the documents in the local cache of the servers, the CDN node servers notify the customer that the delivery task is successfully executed; and then the customer can disclose the access address to the users and provide accesses.

In the process of implementing the present disclosure, the inventor founds that the following problem: when multiple customers submit tasks simultaneously, a handful of customers often operate wrongly or improperly, which causes the system to generate a large amount of junk data or unnecessary tasks, or, the source stations of the customers are in poor performance, thereby reducing the overall performance of the system and decreasing the efficiency of the content delivery.

The embodiments of the present disclosure provides a submitting method, system and non-transitory computer-readable medium for content delivery tasks for solving the deficiency of reduction of overall system performance caused by multiple users submitting a large number of tasks simultaneously, so as to realize the method for submitting contents with task queues.

The submitting method, system and non-transitory computer-readable medium for content delivery tasks provided in the embodiments of the present disclosure allocate the task submitting requests of the user to different task submitting queues according to the priority level of each user in the user priority level model. Since each task submitting queue corresponds to a submitting priority level, when a plurality of users submit a large number of tasks at the same time, users having higher priority levels can submit the tasks faster, which avoids the trouble of reduction of overall system performance caused by users having lower priority levels submitting the tasks first, thereby improving the efficiency of the task submission.

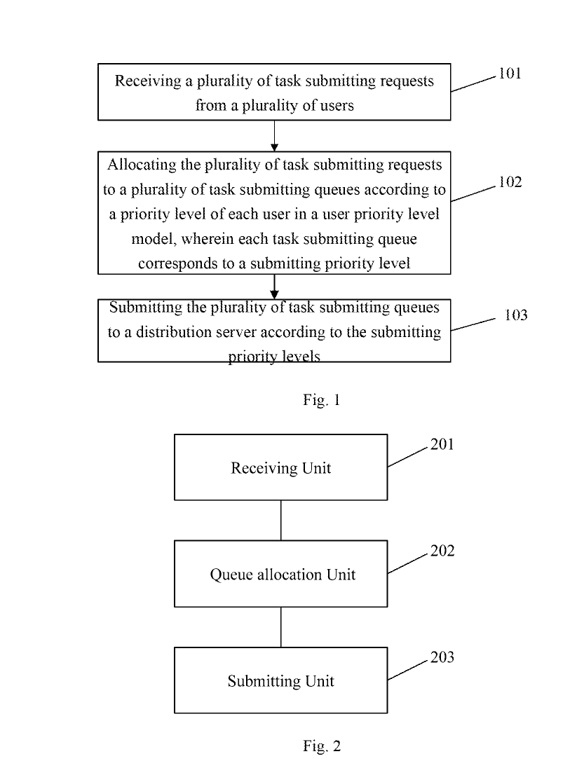

FIG. 1 is a flow chart of the submitting method for content delivery tasks of one embodiment of the present disclosure. As shown in FIG. 1, the method includes the following steps S101-S103.

Step S101 includes receiving by a scheduling center a plurality of task submitting requests from a plurality of users.

Step S102 includes allocating by the scheduling center the plurality of task submitting requests to a plurality of task submitting queues according to a priority level of each user in a user priority level model, wherein each task submitting queue corresponds to a submitting priority level.

Step S103 includes submitting by the scheduling center the plurality of task submitting queues to a distribution server according to the submitting priority levels.

In the embodiments of the present disclosure, the scheduling center (the scheduling center is a server or a server cluster) allocates the task submitting requests of the user to different task submitting queues according to the priority level of each user in the user priority level model. Since each task submitting queue corresponds to a submitting priority level, when a plurality of users submit a large number of tasks at the same time, the method allows the users having higher priority levels to submit their tasks first, which avoids the reduction of overall system performance caused by the users having lower priority levels submitting the tasks first, thereby improving the overall efficiency of the task submission.

In the embodiment shown in FIG. 1, before receiving by a scheduling center a plurality of task submitting requests from a plurality of users in step S101, the process of determining the user priority level model may include:

dividing by a scheduling center a plurality of submission performance ranges according to the submission performances of historical task submitting requests;

setting by the scheduling center a plurality of priority levels according to the plurality of submission performance ranges; and

determining by the scheduling center the user priority level model of each user according to the submission performance of the historical task submitting requests of said each user with reference to the plurality of submission performance ranges.

In the process of determining the user priority level model in this embodiment, the scheduling center determines the user's priority level according to the historical task submitting performances of the user, which, compared to determining the priority level based on only one task submitting performance of the user, takes into account the long-term operation situations of the user and the source station performance, and thus the data is more accurate.

In the embodiments shown in FIG. 1, the submission performance of each user is determined at least based on the amount of tasks submitted, the submitting durations and the number of times of submitting errors. As such, the process of determining to which task submitting queue the task submitting request of the user should be allocated according to the priority level of the user in the user priority level model may include: for example, obtaining a sum of weights of the mount of tasks submitted, the submitting durations and the number of times of submitting errors by allocating corresponding weighted values to the amount of tasks submitted, the submitting durations and the number of times of submitting errors, and obtaining a specific value of the submission performance of the user.

After the submission performance range to which the specific value belongs is determined, the priority level of the user can be determined. Therefore the task submitting requests of the user can be allocated to the task submitting queues having different submitting priority levels. It should be understood that the priority levels of the users and the submitting priority levels of the task submitting queues are not always in one-to-one correspondence. This is because that the number of user priority levels corresponding to the plurality of task submitting requests to be delivered to the distribution server at the same time is not necessarily equal to the number of all the user priority levels. Namely, the user priority levels corresponding to the plurality of task submitting requests may not include all the user priority levels, and the number of the submitting priority levels of the task submitting queues is equal to the number of the user priority levels corresponding to the plurality of task submitting requests currently submitted.

In this embodiment, by determining the submission performance based on the amount of tasks submitted, the submitting durations and the number of times of submitting errors, it is possible to acquire the task submission speed of the user. The speed determines the priority level of the user. The tasks of the users with higher task submission speeds will be submitted first, so as to avoid the risks of system performance reduction and even system breakdown caused by tasks stacking by submitting the tasks with lower speeds first. As a further optimization of this embodiment, in the embodiment of the present disclosure, the users whose operation error possibility is greater than a predetermined threshold and/or users whose source station performance value is lower than a predetermined threshold are determined to have the lowest priority level. During the process of task submission, the setting of the lowest priority level can cause errors to the submitting process. Therefore, the task submitting requests which can easily affect other users are allocated to a separate task submitting queue, such that theses task submitting requests are isolated from the task submitting requests of said other users, thereby reducing the influence to the task submission process of said other users.

As a further optimization of the embodiment shown in FIG. 1, after allocating by the scheduling center the plurality of task submitting requests to a plurality of task submitting queues according to a priority level of each user in a user priority level model in Step 102 in the embodiment of the present disclosure, the method further includes the following steps S1021-S1022.

Step S1021 includes setting by the scheduling center different content priority levels for the plurality of task submitting requests in the same task submitting queue according to a type of the content of the task submitting request.

Step S1022 includes sequencing by the scheduling center the plurality of task submitting requests in the same task submitting queue according to the content priority levels.

In this embodiment, the scheduling center sequences the content priority levels of the task submitting requests in the same queue, i.e., performs priority level determination again for the task submitting requests belonging to the same submitting priority level. The type of the content may be manifested as timeliness; hence the content which has a higher requirement for timeliness, i.e., which one is more urgent, such as news, can be treated first, and the content which has a lower requirement for timeliness and has an overlarge volume will be responded at last. This embodiment can satisfy the user's requirement while keeping good overall system performances.

In the embodiments of the present disclosure, when a task submitting request of a new user is allocated to a task submitting queue in which there are a plurality of tasks to be submitted, the scheduling center can also determine the content priority level corresponding to the task submitting request of the new user, and allocate, according to the content priority level, the task submitting request of the new user after the task belonging to the content priority level.

FIG. 2 is a schematic structural view of the submitting system for content delivery tasks of one embodiment of this disclosure. As shown in FIG. 2, the system includes a receiving unit 201, a queue allocation unit 202 and submitting unit 203.

The receiving unit 201 is configured to receive a plurality of task submitting requests from a plurality of users;

The queue allocation unit 202 is configured to allocate the plurality of task submitting requests received by the receiving unit 201 to a plurality of task submitting queues according to a priority level of each user in a user priority level model, wherein each task submitting queue corresponds to a submitting priority level;

The submitting unit 203 is configured to submit the plurality of task submitting queues, to which a plurality of task submitting requests are submitted by the queue allocation unit 202, to a distribution server according to the submitting priority levels.

In this embodiment, the submitting system for content delivery tasks is the scheduling center in the CDN system, and the scheduling center is a server or a server cluster, wherein each unit may be an individual server or server cluster; at this time, an interaction between the above units manifest as an interaction between the server or server cluster corresponding to each unit, and the plurality of server or server clusters jointly form the submitting system for content delivery tasks of this disclosure.

In particular, the submitting system for content delivery tasks of this disclosure jointly formed by the plurality of servers or server clusters includes:

a receiving server or server cluster configured to receive a plurality of task submitting requests from a plurality of users;

a queue allocation server or server cluster configured to allocate the plurality of task submitting requests received by the receiving server or server cluster to a plurality of task submitting queues according to a priority level of each user in a user priority level model, wherein each task submitting queue corresponds to a submitting priority level; and

a submitting server or server cluster configured to submit the plurality of task submitting queues, to which a plurality of task submitting requests are submitted by the queue allocation server or server cluster, to a distribution server according to the submitting priority levels.

In an alternative embodiment, several units of the above plurality of units may jointly form a server or server cluster. For example, the receiving unit and the queue allocation unit jointly form a first server or a first server cluster, and the submitting unit constitutes a second server or a second server cluster.

At this time, the interaction between the above units manifests as an interaction between each first server and the second server or an interaction between the first server cluster and second server cluster, and the first and second servers or the first and second server clusters jointly form the submitting system for content delivery tasks of this disclosure.

As a further optimization of the embodiment shown in FIG. 2, the system in this embodiment also includes a model determining unit 204, which is connected to the queue allocation unit 202 and is configured to divide a plurality of submission performance ranges according to the submission performances of the historical task submitting requests, set a plurality of priority levels according to the plurality of submission performance ranges, and determine the user priority level model of each user according to the submission performance of the historical task submitting requests of said each user with reference to the plurality of submission performance ranges.

The model determining unit in this embodiment may be a server or a server cluster. At this time, the interaction between the model determining unit and all units in the embodiment shown in FIG. 2 manifests as an interaction between the servers or server clusters corresponding to each of the units, and the plurality of servers or server clusters jointly form the submitting system for content delivery tasks of the present disclosure.

In an alternative embodiment, several units of the above plurality of units may jointly form a server or server cluster. For example, the receiving unit and the queue allocation unit jointly form a first server or a first server cluster, the model determining unit constitutes a second server or a second server cluster, and the submitting unit constitutes a third server or a third server cluster.

At this time, the interaction between the above units manifests as the interaction between each first server to each third server or the interaction between the first server cluster to the third server cluster, and the first to third servers or the first to third server clusters jointly constitute the submitting system for content delivery tasks of this disclosure.

In the embodiments shown in FIG. 2, the submission performance is determined at least based on the amount of tasks submitted, the submitting durations and the number of times of submitting errors.

As a further optimization of the embodiment shown in FIG. 2, the system in this embodiment also includes a queue content sequencing unit 205, which is configured to set different content priority levels for the plurality of task submitting requests in the same task submitting queue according to a type of the content of the task submitting request, and sequence the plurality of task submitting requests in the same task submitting queue according to the content priority levels.

The queue content sequencing unit in this embodiment may be a server or a server cluster. At this time, the interaction between the queue content sequencing unit and all units in the above embodiment manifests as the interaction between the servers or server clusters corresponding to each of the units, and the plurality of servers or server clusters jointly form the submitting system for content delivery tasks of the present disclosure.

In an alternative embodiment, several units of the above mentioned plurality of units may jointly form a server or server cluster. For example, the receiving unit and the queue allocation unit jointly form a first server or a first server cluster, the model determining unit constitutes a second server or a second server cluster, and the submitting unit and the queue content sequencing unit jointly form a third server or a third server cluster.

At this time, the interaction between the above units manifests as the interaction between each first server to each third server or the interaction between the first server cluster to the third server cluster, and the first to third servers or the first to third server clusters jointly form the submitting system for content delivery tasks of this disclosure.

In the embodiment of this disclosure, when the distribution server receives the tasks and delivers the tasks to other nodes, if the delivery fails, it is not necessary to notify the user to try again manually, the distribution server automatically performs a redelivery process, and transmits a notification of successful delivery to the user after the delivery is successful.

In the embodiments of the present disclosure, the related functional modules can be realized by hardware processors.

The present disclosure provides a non-transitory computer readable storage medium in which one or more programs including execution instructions are stored, the execution instructions being executable by electronic devices having control interfaces for executing the related steps in the above method embodiments. For example, the steps include:

receiving a plurality of task submitting requests from a plurality of users;

allocating the plurality of task submitting requests to a plurality of task submitting queues according to a priority level of each user in a user priority level model, wherein each task submitting queue corresponds to a submitting priority level; and

submitting the plurality of task submitting queue to a distribution server according to the submitting priority levels.

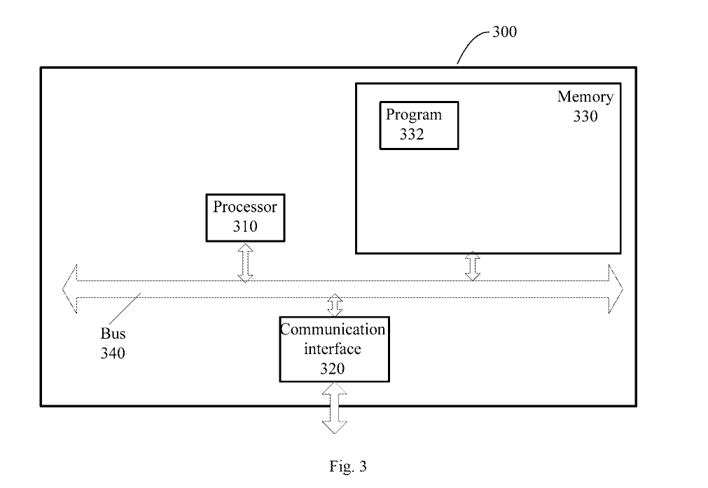

FIG. 3 is a schematic structural view of the device 300 that implements the submitting method for content delivery tasks of the embodiments of the present disclosure. The specific embodiments of the present disclosure do not define the specific implementation manners of the device 300. As shown in FIG. 3, the device 300 may include: a processor 310, a communications interface 320, a memory 330 and a communication bus 340.

Communications between the processor 310, the communications interface 320 and the memory 330 are accomplished via the communication bus 340.

The communications interface 320 is configured to communicate with a network element such as a client.

The processor 310 is configured to execute a program 332 in the memory 330, so as to execute the related steps in the above method embodiments.

In particular, the program 332 may include a program code which includes a computer operation instruction.

The processor 310 may be a Central Processing Unit (CPU), or an Application Specific Integrated Circuit (ASIC), or one or more integrated circuits configured to implement the embodiments of the present disclosure.

The memory 330 is configured to store the program 332. The memory 330 may include a high speed RAM memory, and may also include a non-volatile memory, such as at least one disk memory. The program 332 may in particular be configured to cause the device 300 to execute the following operations:

a receiving step: receiving a plurality of task submitting requests from a plurality of users;

a queue allocation step: allocating the plurality of task submitting requests to a plurality of task submitting queues according to a priority level of each user in a user priority level model, wherein each task submitting queue corresponds to a submitting priority level; and

a submitting step: submitting the plurality of task submitting queue to a distribution server according to the submitting priority levels.

The specific realization of each step in the program 332 can be seen from the corresponding descriptions of the corresponding steps and units in the above embodiments, and will not be described herein. It can be understood by a person skilled in the art that for the convenience and conciseness of the description, the specific working processes of the above described device and modules can be seen from the foregoing descriptions of the corresponding processes in the method embodiments, and will not be described herein.

In the following, the present disclosure will be further explained using a specific embodiment.

The CDN service provider divides five submission performance ranges according to the submission performances of the historical task submitting requests, including the amount of tasks submitted, the submitting time durations and the number of times of submitting errors. For example, the five ranges are 50-60, 60-70, 70-80, 80-90 and 90-100 respectively. Then the CDN service provider sets five priority levels according to the five submission performance ranges. The submission performances of the historical task submitting requests of customers A, B, C and D are 93, 72, 78 and 55 respectively. Thus the priority level model of each customer is determined, wherein customer A belongs to the first priority level, customers B and C to the third priority level, and customer D to the fifth priority level. When customers A, B, C and D submit tasks to the CDN service provider simultaneously, the server accepts their task submitting requests, and allocates, according to the priority levels of the customers, the task submitting request of customer A to the task submitting queue corresponding to the first submitting priority level, the task submitting requests of customers B and C to the task submitting queue corresponding to the second submitting priority level, and the task submitting request of customer D to the task submitting queue corresponding to the third submitting priority level.

In the task submitting queue corresponding to the second submitting priority level, since the content submitted by customer B is news which has a higher requirement for timeliness, while the content submitted by customer C is a movie which does not have a high requirement for timeliness, the content priority level of the task submitting request of customer B is higher than that of the task submitting request of customer C. Thus, when submitting the queues, the tasks of customer B will be submitted to the distribution server first.

The present disclosure may further provide a non-transitory computer-readable medium for content delivery tasks. The non-transitory computer-readable medium may include executable instructions, wherein the executable instructions, when executed by a processor, cause the processor to: receive a plurality of task submitting requests from a plurality of users, allocate the plurality of task submitting requests to a plurality of task submitting queues according to a priority level of each user in a user priority level model wherein each task submitting queue may correspond to a submitting priority level, and submit the plurality of task submitting queues to a distribution server according to the submitting priority levels.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A method for submitting content delivery tasks, comprising:
receiving a plurality of task submitting requests from a plurality of users;
allocating the plurality of task submitting requests to a plurality of task submitting queues according to a priority level of each user in a user priority level model, wherein each task submitting queue corresponds to a submitting priority level; and
submitting the plurality of task submitting queues to a distribution server according to the submitting priority levels.

2. The method according to claim 1, before receiving a plurality of task submitting requests from a plurality of users, the method further comprising:
dividing a plurality of submission performance ranges according to submission performances of historical task submitting requests;
setting a plurality of priority levels according to the plurality of submission performance ranges; and
determining user priority level model of each user according to the submission performances of historical task submitting requests of said each user with reference to the plurality of submission performance ranges.

3. The method according to claim 2, wherein the submission performances are determined at least according to an amount of tasks submitted, submitting durations and a number of times of submitting errors.

4. The method according to claim 1, after allocating the plurality of task submitting requests to a plurality of task submitting queues according to a priority level of each user in a user priority level model, the method further comprising:
setting different content priority levels for the plurality of task submitting requests in the same task submitting queue according to a type of a content of the task submitting request; and
sequencing the plurality of task submitting requests in the same task submitting queue according to the content priority levels.

5. An electronic device for content delivery tasks, comprising:
at least one processor; and
a memory communicably connected with the at least one processor for storing instructions executable by the at least one processor, wherein execution of the instructions by the at least one processor causes the at least one processor to:
receive a plurality of task submitting requests from a plurality of users;
allocate the plurality of task submitting requests to a plurality of task submitting queues according to a priority level of each user in a user priority level model, wherein each task submitting queue corresponds to a submitting priority level; and
submit the plurality of task submitting queue to a distribution server according to the submitting priority level.

6. The electronic device according to claim 5, wherein the execution of the instructions by the at least one processor further causes the at least one processor to:
divide a plurality of submission performance ranges according to submission performances of historical task submitting requests, set a plurality of priority levels according to the plurality of submission performance ranges, and determine user priority level model of each user according to the submission performances of historical task submitting requests of said each user with reference to the plurality of submission performance ranges.

7. The electronic device according to claim 6, wherein the submission performances are determined at least according to an amount of tasks submitted, submitting durations and a number of times of submitting errors.

8. The electronic device according to claim 5, wherein the execution of the instructions by the at least one processor further causes the at least one processor to:
set different content priority levels for the plurality of task submitting requests in the same task submitting queue according to a type of a content of the task submitting request, and sequence the plurality of task submitting requests in the same task submitting queue according to the content priority levels.

9. A non-transitory computer-readable storage medium storing executable instructions, wherein the executable instructions, when executed by a processor, cause the processor to:
receive a plurality of task submitting requests from a plurality of users;
allocate the plurality of task submitting requests to a plurality of task submitting queues according to a priority level of each user in a user priority level model, wherein each task submitting queue corresponds to a submitting priority level; and
submit the plurality of task submitting queues to a distribution server according to the submitting priority levels.

10. The non-transitory computer-readable storage medium according to claim 9, wherein the executable instructions, when executed by the processor, before receiving a plurality of task submitting requests from a plurality of users, further cause the processor to:
divide a plurality of submission performance ranges according to submission performances of historical task submitting requests;
set a plurality of priority levels according to the plurality of submission performance ranges; and
determine user priority level model of each user according to the submission performances of historical task submitting requests of said each user with reference to the plurality of submission performance ranges.

11. The non-transitory computer-readable storage medium according to claim 10, wherein the submission performances are determined at least according to an amount of tasks submitted, submitting durations and a number of times of submitting errors.

12. The non-transitory computer-readable storage medium according to claim 9, wherein the executable instructions, when executed by the processor, after allocating the plurality of task submitting requests to a plurality of task submitting queues according to a priority level of each user in a user priority level model, further cause the processor to:
set different content priority levels for the plurality of task submitting requests in the same task submitting queue according to a type of a content of the task submitting request; and
sequence the plurality of task submitting requests in the same task submitting queue according to the content priority levels.
